(19) United States
(12) Patent Application Publication
(10) Pub. No.: US 2022/0276339 A1
(43) Pub. Date: Sep. 1, 2022

(54) CALIBRATION METHOD AND APPARATUS FOR SENSOR, AND CALIBRATION SYSTEM

(71) Applicant: Shanghai SenseTime Intelligent Technology Co., Ltd., Shanghai (CN)

(72) Inventors: Zheng MA, Shanghai (CN); Guohang YAN, Shanghai (CN); Chunxiao LIU, Shanghai (CN); Jianping SHI, Shanghai (CN)

(21) Appl. No.: 17/747,717

(22) Filed: May 18, 2022

Related U.S. Application Data
(63) Continuation of application No. PCT/CN2020/123636, filed on Oct. 26, 2020.

(30) Foreign Application Priority Data
Nov. 18, 2019 (CN) 201911129776.2

(51) Int. Cl. G01S 7/40; G06T 7/70; G06T 7/80; H04N 17/00; G01S 13/86; G01S 13/89

(52) U.S. Cl. CPC G01S 7/40; G06T 7/70; G06T 7/80; H04N 17/002; G01S 13/867; G01S 13/89; G06T 2207/10028; G06T 2207/30244

(57) ABSTRACT

Methods, apparatus, systems, and storage media for calibrating sensors are provided. In one aspect, a calibration method for a sensor having a camera and a radar includes: collecting a plurality of images of a calibration plate located within a common field of view range of the radar and the camera in respective position-orientations by the camera; collecting multiple sets of radar point cloud data of the calibration plate in the respective position-orientations by the radar; establishing corresponding relationships between the plurality of images and the multiple sets of radar point cloud data based on the respective position-orientations; determining multiple sets of target radar point cloud data matched with the calibration plate in the respective position-orientations among the multiple sets of radar point cloud data; and determining a target extrinsic parameter between the radar and the camera according to the target radar point cloud data and corresponding relationships.

### CROSS REFERENCE TO RELATED APPLICATIONS

This application is a continuation application of International Application No. PCT/CN2020/123636 filed on Oct. 26, 2020, which claims priority to a Chinese Patent Application No. 201911129776.2, filed on Nov. 18, 2019 and titled “CALIBRATION METHOD AND APPARATUS FOR SENSOR, STORAGE MEDIUM, AND CALIBRATION SYSTEM”, the entire contents of which are incorporated herein by reference.

### TECHNICAL FIELD

The present disclosure relates to the field of computer vision, and more particular, to a calibration method and apparatus for a sensor, and a calibration system.

### BACKGROUND

With the continuous development of computer vision field, more and more sensors are deployed in machine devices, and different sensors can provide different types of data. For example, a machine device includes a combination of a radar and a camera, based on the data provided by the radar and the camera, the machine device can learn to perceive a surrounding environment.

However, in a process of using the radar and the camera at the same time, an accuracy of an extrinsic parameter between the radar and the camera determines an accuracy of environment perception. In a process of calibrating the extrinsic parameter between the radar and the camera, calibration accuracy is mainly determined by an intrinsic parameter of the camera, an extrinsic parameter of a calibration plate relative to the camera, and a matching accuracy of radar point cloud data.

### SUMMARY

The present disclosure provides a calibration method and apparatus for a sensor, and a calibration system, which can solve a technical problem that a calibration result is not accurate enough due to errors of manually matching the point cloud data accumulated many times in the calibration process.

According to a first aspect of the embodiments of the present disclosure, there is provided a calibration method for a sensor including a camera and a radar, the calibration method including: collecting a plurality of images of a calibration plate in respective position-orientations by the camera, wherein the calibration plate is located within a common field of view range of the radar and the camera; collecting multiple sets of radar point cloud data of the calibration plate in the respective position-orientations by the radar; establishing corresponding relationships between the plurality of images and the multiple sets of radar point cloud data based on the respective position-orientations of the calibration plate, wherein, for each of the respective position-orientations of the calibration plate, a corresponding relationship exists between an image of the plurality of images and a set of the multiple sets of radar point cloud data that are collected in the respective position-orientation of the calibration plate; respectively determining multiple sets of target radar point cloud data matched with the calibration plate in the respective position-orientations among the multiple sets of radar point cloud data; and determining a target extrinsic parameter between the radar and the camera according to the multiple sets of target radar point cloud data and multiple sets of corresponding relationships.

According to a second aspect of the embodiments of the present disclosure, there is provided a calibration apparatus for a sensor including a camera and a radar, the calibration apparatus including: at least one processor; and at least one non-transitory memory coupled to the at least one processor and storing programming instructions for execution by the at least one processor to perform operations including: collecting a plurality of images of a calibration plate in respective position-orientations by the camera, wherein the calibration plate is located within a common field of view range of the radar and the camera; collecting multiple sets of radar point cloud data of the calibration plate in the respective position-orientations by the radar; establishing corresponding relationships between the plurality of images and the multiple sets of radar point cloud data based on the respective position-orientations of the calibration plate, wherein, for each of the respective position-orientations of the calibration plate, a corresponding relationship exists between an image of the plurality of images and a set of the multiple sets of radar point cloud data that are collected in the respective position-orientation of the calibration plate; respectively determining multiple sets of target radar point cloud data matched with the calibration plate in the respective position-orientations among the multiple sets of radar point cloud data; and determining a target extrinsic parameter between the radar and the camera according to the multiple sets of target radar point cloud data and multiple sets of corresponding relationships.

According to a third aspect of the embodiments of the present disclosure, there is provided a calibration system, including: a camera; a radar; a calibration plate, wherein the calibration plate is located within a common field of view range of the camera and the radar, and position-orientation information of the calibration plate at different collection times is different; and a calibration apparatus including: at least one processor; and at least one non-transitory memory coupled to the at least one processor and storing programming instructions for execution by the at least one processor to perform operations including: collecting a plurality of images of the calibration plate in respective position-orientations by the camera; collecting multiple sets of radar point cloud data of the calibration plate in the respective position-orientations by the radar; establishing corresponding relationships between the plurality of images and the multiple sets of radar point cloud data based on the respective position-orientations of the calibration plate, wherein, for each of the respective position-orientations of the calibration plate, a corresponding relationship exists between an image of the plurality of images and a set of the multiple sets of radar point cloud data that are collected in the respective position-orientation of the calibration plate; respectively determining multiple sets of target radar point cloud data matched with the calibration plate in the respective position-orientations among the multiple sets of radar point cloud data; and determining a target extrinsic parameter between the radar and the camera according to the multiple sets of target radar point cloud data and multiple sets of corresponding relationships.

Technical solutions provided by the embodiments of the present disclosure may include following beneficial effects.

In the embodiments of the present disclosure, a plurality of images of the calibration plate in respective position-orientations can be collected by the camera, and multiple sets of radar point cloud data of the calibration plate in the respective position-orientations can be collected by the radar; corresponding relationships between the plurality of images and the multiple sets of radar point cloud data can be established based on the respective position-orientations of the calibration plate; and a target extrinsic parameter between the radar and the camera can be determined according to the multiple sets of target radar point cloud data and the multiple sets of corresponding relationships after multiple sets of target radar point cloud data matched with the calibration plate in the respective position-orientations are respectively determined among the multiple sets of radar point cloud data, and thus a purpose of automatically determining the target radar point cloud data matched with the calibration plate in the multiple sets of radar point cloud data can be realized, and the technical problem that calibration result is not accurate enough due to errors of manually matching the point cloud data accumulated many times in the calibration process can be solved. This means that a calibration accuracy of the sensor can he improved by reducing matching errors according to the embodiments of the present disclosure, that is, an accuracy of the target extrinsic parameter between the radar and the camera can be improved.

It is to be understood that the above general descriptions and the below detailed descriptions are merely exemplary and explanatory, and are not intended to limit the present disclosure.

### BRIEF DESCRIPTION OF THE DRAWINGS

The accompanying drawings, which are incorporated in and constitute a part of this specification, illustrate embodiments consistent with the present disclosure and, together with the description, serve to explain the principles of the disclosure.

FIG. 1 is a flowchart showing a calibration method for a sensor according to an exemplary embodiment of the present disclosure.

FIG. 2 is a schematic diagram showing a common field of view according to an exemplary embodiment of the present disclosure.

FIG. 3 is a schematic diagram showing a calibration plate in different orientations according to an exemplary embodiment of the present disclosure.

FIG. 4 is a schematic diagram showing a scene of a corresponding relationship between a laser beam emitted by a radar and a calibration plate according to an exemplary embodiment of the present disclosure.

FIG. 5 is a flowchart showing a calibration method for a sensor according to another exemplary embodiment of the present disclosure.

FIG. 6 is a schematic diagram showing a first image including another calibration plate according to an exemplary embodiment of the present disclosure.

FIG. 7A is a schematic diagram showing a scene in which a preset point is projected according to an exemplary embodiment of the present disclosure.

FIG. 7B is a schematic diagram showing a scene in which a coordinate pair with a corresponding relationship is determined according to an exemplary embodiment of the present disclosure.

FIG. 8 is a flowchart showing a calibration method for a sensor according to another exemplary embodiment of the present disclosure.

FIG. 9 is a flowchart showing a calibration method for a sensor according to still another exemplary embodiment of the present disclosure.

FIG. 10 is a schematic diagram showing a scene in which a target plane is determined according to an exemplary embodiment of the present disclosure.

FIG. 11 is a flowchart showing another calibration method for a sensor according to an exemplary embodiment of the present disclosure.

FIG. 12 is a schematic diagram showing determination of a plurality of first vectors according to an exemplary embodiment of the present disclosure.

FIG. 13 is a schematic diagram showing a scene in which target radar point cloud data is determined according to an exemplary embodiment of the present disclosure.

FIG. 14 is a flowchart showing a calibration method for a sensor according to still another exemplary embodiment of the present disclosure.

FIG. 15 is a flowchart showing a calibration method for a sensor according to an exemplary embodiment of the present disclosure.

FIG. 16 is a flowchart showing a calibration method for a sensor according to still another exemplary embodiment of the present disclosure.

FIG. 17A is a schematic diagram showing a scene in which the calibration plate is projected by the radar according to an exemplary embodiment of the present disclosure.

FIG. 17B is a schematic diagram showing a scene in which the calibration plate is projected by the radar according to another exemplary embodiment of the present disclosure.

FIG. 18 is a schematic diagram showing deployment of a radar and a camera on a vehicle according to an exemplary embodiment of the present disclosure.

FIG. 19 is a schematic diagram showing positions of a calibration plate and another calibration plate corresponding to a radar and a camera deployed on a vehicle according to an exemplary embodiment of the present disclosure.

FIG. 20 is a schematic diagram showing a scene where another calibration plate is at an edge of the field of view of a camera according to an exemplary embodiment of the present disclosure.

FIG. 21 is a block diagram showing a calibration apparatus for an extrinsic parameter between a radar and a camera according to an exemplary embodiment of the present disclosure.

FIG. 22 is a block diagram showing a calibration apparatus for an extrinsic parameter between a radar and a camera according to another exemplary embodiment of the present disclosure.

### DETAILED DESCRIPTION

Exemplary embodiments will be described in detail herein, with the illustrations thereof represented in the drawings. When the following descriptions involve the drawings, like numerals in different drawings refer to like or similar elements unless otherwise indicated. The implementation manners described in the following exemplary embodiments do not represent all embodiments consistent with the present disclosure. Rather, they are merely examples of apparatuses and methods consistent with some aspects of the present disclosure as detailed in the appended claims.

The terms used in the present disclosure are for the purpose of describing particular examples only, and are not intended to limit the present disclosure. The singular forms “a/an”, “the” and “said” used in the present disclosure and the appended claims are also intended to include plurality, unless the context clearly indicates other meanings. It should also be understood that the term “and/or” as used herein refers to and includes any and all possible combinations of one or more of the associated listed items.

It should be understood that, although terms “first”, “second,” “third,” and the like may be used to describe various information in the present disclosure, the information should not be limited to these terms. These terms are only used to distinguish the same type of information from each other. For example, without departing from the scope of the present disclosure, first information may also be referred to as second information, and similarly, second information may also be referred to as first information. Depending on the context, the word “if” as used herein may be interpreted as “when” or “upon” or “in response to determining”.

The present disclosure provides a calibration method for a sensor. The calibration for the sensor refers to a calibration for an intrinsic parameter and/or an extrinsic parameter of the sensor.

The intrinsic parameter of the sensor refers to a parameter used to reflect the characteristics of the sensor itself. After the sensor leaves a factory, the intrinsic parameter is unchanged in theory, however, in actual use, the intrinsic parameter may change. Taking a sensor including a camera as an example, as the camera is used over time, changes in a position relationship of various parts of the camera will lead to changes in the intrinsic parameter. A calibrated intrinsic parameter is generally only a parameter that approximates a real intrinsic parameter, not a true value of the intrinsic parameter.

Taking a sensor including a camera and a radar as an example, the intrinsic parameter of the sensor can include an intrinsic parameter of the camera and an intrinsic parameter of the radar.

The intrinsic parameter of the camera refers to a parameter used to reflect the characteristics of the camera itself, and may include but is not limited to at least one of the followings, that is, the intrinsic parameter of the camera may be one or more of a plurality of parameters listed below: u₀, v₀, Sₓ, S_{y}, f, and r. Here, u₀ and v₀ respectively represent numbers of horizontal and vertical pixels that differ between the origin of the pixel coordinate system and the origin of the camera coordinate system where the camera is located, in pixels; Sₓ and S_{y} are numbers of pixels per unit length in the horizontal and vertical directions, and the unit length may be a millimeter. f is a focal length of the camera; and r is a distance from the pixel to the center of the imager due to image distortion. In the embodiment of the present disclosure, the center of the imager is a focus center of the camera. The camera described in the present disclosure may be a camera, a video camera, or other device with a photographing function, which is not limited in the present disclosure.

The intrinsic parameter of the radar refers to a parameter that can be used to reflect the characteristics of the radar itself, and may include, but is not limited to, at least one of the followings, that is, the intrinsic parameter of the radar may be one or more of a plurality of parameters listed below: power and type of the transmitter, sensitivity and type of the receiver, parameters and type of the antenna, a number and type of the display. etc. The radar described in the present disclosure may be a Light Detection and Ranging (LiDAR) system, or a radio radar, which is not limited in the present disclosure.

In the case that a number of the sensor is only one, the extrinsic parameter of the sensor refers to the parameter representing a conversion relationship between a position of an object in a world coordinate system and a position of the object in a sensor coordinate system. It should be noted that, in the case that the number of the sensor is more than one, the extrinsic parameter of the sensor also includes parameters reflecting a conversion relationship among the plurality of sensor coordinate systems. The following also takes the sensor including the camera and the radar as an example, and thus the extrinsic parameter of the sensor includes an extrinsic parameter of the camera and an extrinsic parameter of the radar.

The extrinsic parameter of the camera refers to a parameter used to convert a point from a world coordinate system to a camera coordinate system. In the embodiment of the present disclosure, an extrinsic parameter of a calibration plate relative to a camera can be used to reflect change parameters of the position and/or an orientation required for conversion of the calibration plate in the world coordinate system to the camera coordinate system, etc.

The extrinsic parameter of a camera may include, but is not limited to, one or a combination of a plurality of the following parameters: change parameters of the position and/or the orientation required for conversion of the calibration plate in the world coordinate system to the camera coordinate system, etc.

In addition, for the camera, distortion parameters also need to be considered. The distortion parameters include radial distortion parameters and tangential distortion coefficients. The radial distortion and tangential distortion are position deviations of an image pixel along the length direction or the tangent direction with the distortion center as the center point, respectively, thereby resulting in image deformation.

The change parameters of the position and/or the orientation required for conversion of the calibration plate in the world coordinate system to the camera coordinate system may include a rotation matrix R and a translation matrix T. Here, the rotation matrix R is rotation angle parameters respectively relative to three coordinate axes x, y and z when the calibration plate in the world coordinate system is to be converted to the camera coordinate system, and the translation matrix T is translation parameters of an origin when the calibration plate in the world coordinate system is to be converted to the camera coordinate system.

The extrinsic parameter of the radar refers to the parameter used to convert a point from the world coordinate system to the radar coordinate system. In the embodiment of the present disclosure, an extrinsic parameter of a calibration plate relative to a radar can be used to reflect the change parameters of the position and/or the orientation required for conversion of the calibration plate in the world coordinate system to the radar coordinate system, etc.

A target extrinsic parameter between the camera and the radar refers to a parameter used to reflect a conversion relationship between the radar coordinate system and the camera coordinate system. An extrinsic parameter between the camera and the radar can reflect changes of the radar coordinate system relative to the camera coordinate system in position and orientation, etc.

For example, the sensor can include the camera and the radar, the calibration for the sensor refers to the calibration for one or a combination of a plurality of the intrinsic parameter of the camera, the intrinsic parameter of the radar, and the target extrinsic parameter between the camera and the radar. Here, the above-mentioned intrinsic parameter and/or the extrinsic parameter can be determined by means of a calibration plate, for example, the target extrinsic parameter between the camera and the radar can be determined by means of the extrinsic parameter of the calibration plate relative to the camera and the extrinsic parameter of the calibration plate relative to the radar. It should be noted that, the actually calibrated parameters may include but are not limited to those listed above.

For example, as shown in FIG. 1, in the case that the sensor includes the camera and the radar, the calibration method for the sensor may include the following steps.

In step 101, a plurality of images of the calibration plate in respective position-orientations are collected by the camera, and multiple sets of radar point cloud data of the calibration plate in the respective position-orientations are collected by the radar.

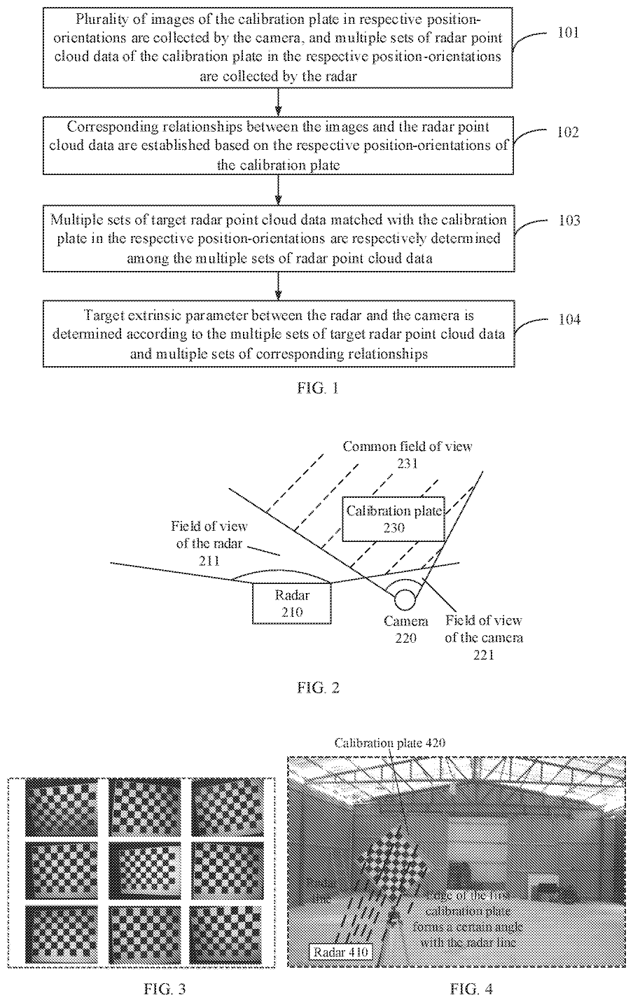

In the embodiment of the present disclosure, a field of view is a range that can be covered by the emitted light, electromagnetic waves, etc., when the position of the sensor remains unchanged. In the embodiment of the present disclosure, taking the sensor including a radar as an example, the field of view refers to a range that can be covered by laser beams or electromagnetic waves emitted by the radar, and taking the sensor including a camera as an example, the field of view refers to a range that can be captured by the lens of the camera. In the embodiment of the present disclosure, the calibration plate 230 is located in a range of a common field of view 231 of the radar 210 and the camera 220, as shown in FIG. 2, for example. Here, the range of the common field of view 231 refers to a part where ranges covered by respective sensing elements included in the sensor overlap with each other, that is, the part (the part indicated by the dashed line in the figure) where the range covered by the radar 210 (the field of view 211 of the radar in the figure) and the range captured by the camera 220 (the field of view 221 of the camera in the figure) overlap.

In the embodiment of the present disclosure, the calibration plate can be a circular, rectangular or square array plate with a fixed pitch pattern. For example, as shown in any one of the images in FIG. 3, a rectangular array plate with black and white grids alternated can be used. In addition, the pattern of the calibration plate can also include other regular patterns, or patterns that are irregular but have characteristic parameters such as characteristic point sets, characteristic edges, and the like. The shape, pattern and the like of the calibration plate are not limited here.

In this step, in order to improve the accuracy of the target extrinsic parameter between the radar and the camera, the number of the images collected by the camera may be multiple, for example, more than 20. In the embodiment of the present disclosure, position-orientation information of the calibration plate in the collected plurality of images may be different, that is, there are at least some images in the plurality of images that respectively show the different position-orientations of the calibration plate, wherein the position-orientation information includes information for reflecting an orientation of a calibration plate in a three-dimensional space. For example, in the plurality of images shown in FIG. 3, the calibration plate has orientation changes in at least one of three dimensions of a pitch angle, a roll angle, and a yaw angle. This means that the plurality of images can be collected when the calibration plate is in different positions and/or orientations, that is, the position-orientation information of the calibration plate included in different images may be same or different, and there are at least two images including different position-orientation information of the calibration plate. Here, each image needs to include a complete calibration plate.

The calibration plate in different position-orientations include: a calibration plate which is different from a distance between the camera and the radar and/or an orientation in a horizontal direction. In addition, in the process of capturing the images by the camera, the calibration plate may be in a static state. For example, a bracket can be used to fix the calibration plate. In one implementation, the collected plurality of images may include images of the calibration plate at various distances (i.e., small distance, moderate distance, large distance, etc.) in different position-orientations. In order to ensure that the laser generated by the radar can cover the complete calibration plate, the calibration plate is usually kept far away from the radar in the process of deploying the calibration plate. In the process of collecting images of the calibration plate deployed at different distances, for the case where the distance d1 from the calibration plate to the camera is relatively small, for example, the distance d1 is less than a distance threshold D1, a plurality of images including the calibration plate in different orientations are collected. For the case where d1 is relatively large, for example, d1 is greater than a distance threshold D2, a plurality of images including the calibration plate in different orientations can be additionally collected. For the case where the distance d1 is moderate, for example, the distance d1 is between the above two distance thresholds, that is, D1<d1<D2, a plurality of images including the calibration plate in different orientations can be additionally collected. In this way, the images captured at various distances between the calibration plate and the camera can be obtained.

In the embodiment of the present disclosure, in order to more accurately determine the extrinsic parameter of the calibration plate relative to the camera subsequently, the plurality of images may include a complete calibration plate. For example, in the plurality of images shown in FIG. 3, a ratio of the area of the calibration plate to the area of the image is different. For example, when the distance d1 is relatively large, the area of the calibration plate in the image occupies a relatively small proportion, and when the distance d1 is relatively small, the area of the calibration plate in the image occupies a relatively large proportion.

Taking the radar being a lidar as an example, radar point cloud data is data including a plurality of radar points generated by the laser emitted by the radar passing through the calibration plate with different position-orientation information. For example, as shown in FIG. 4, the edges of the calibration plate 420 are not parallel to the laser or electromagnetic waves emitted by the radar 410, and there may be a certain angle, so as to ensure that each edge of the calibration plate 420 can be passed through by the laser or electromagnetic waves emitted by the radar 410, so that target radar point cloud data matched with the calibration plate in the radar point cloud data can be better determined subsequently.

In step 102, corresponding relationships between the images and the radar point cloud data are established based on the respective position-orientations of the calibration plate.

Corresponding to each of the respective position-orientations of the calibration plate, a corresponding relationship between an image collected by the camera in this position-orientation and radar point cloud data generated by the radar in this position-orientation can be established.

In step 103, multiple sets of target radar point cloud data matched with the calibration plate in the respective position-orientations are respectively determined among the multiple sets of radar point cloud data.

In the embodiment of the present disclosure, for a certain position-orientation, in a set of radar point cloud data collected in the position-orientation, the point cloud data corresponding to the calibration plate is the target radar point cloud data matched with the calibration plate.

In step 104, a target extrinsic parameter between the radar and the camera is determined according to the multiple sets of target radar point cloud data and multiple sets of corresponding relationships. Herein, the target extrinsic parameter between the radar and the camera is an extrinsic parameter between the camera and the radar to be calibrated in the embodiment of the present disclosure.

According to the embodiment of the present disclosure, the purpose of automatically determining the target radar point cloud data matched with the calibration plate in the multiple sets of radar point cloud data can be realized, and the technical problem that calibration result is not accurate enough due to errors of manually matching the point cloud data accumulated many times in the calibration process can be solved. This means that a calibration accuracy of the sensor can be improved by reducing matching errors according to the embodiments of the present disclosure, that is, an accuracy of the target extrinsic parameter between the radar and the camera can be improved.

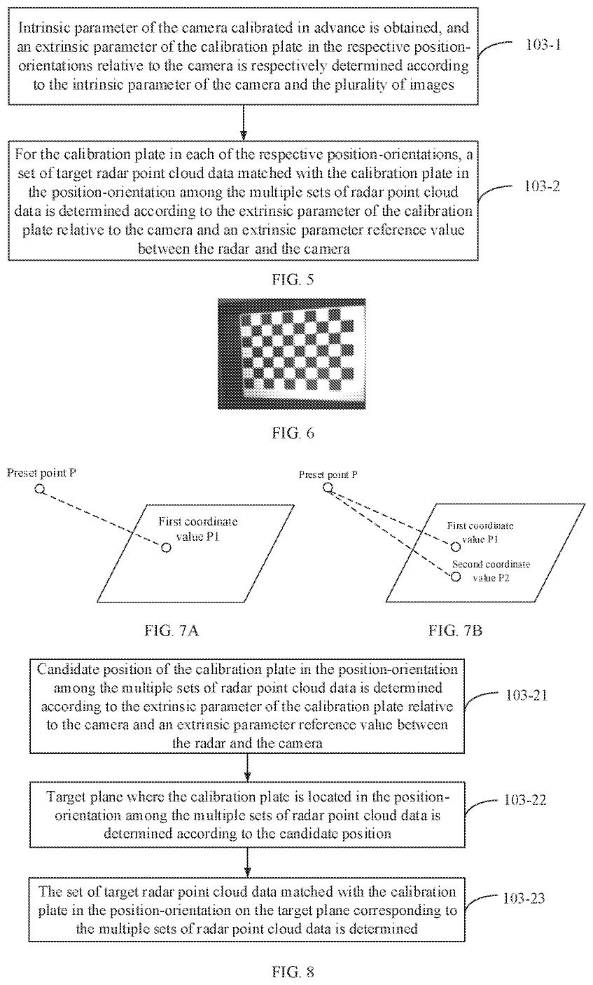

In some optional implementations, such as shown in FIG. 5, step 103 can include the following steps.

In step 103-1, an intrinsic parameter of the camera calibrated in advance is obtained, and an extrinsic parameter of the calibration plate in the respective position-orientations relative to the camera is respectively determined according to the intrinsic parameter of the camera and the plurality of images.

In the embodiment of the present disclosure, in the case that the sensor is calibrated (that is, the target extrinsic parameter between the camera and the radar is calibrated), the intrinsic parameter of the camera previously calibrated can be directly obtained. This means that in the case that the sensor has been calibrated, if a relative position relationship between the camera and the radar changes subsequently, and the sensor needs to be recalibrated, the intrinsic parameter of the camera previously calibrated can be directly used to complete the calibration of the sensor. That is, in the subsequent process of calibrating the sensor, the time and resources consumed for calibrating the intrinsic parameter of the camera can be eliminated.

In the embodiment of the present disclosure, when calibrating the intrinsic parameter of the camera, another calibration plate can be placed in the field of view of the camera, and a plurality of first images including another calibration plate can be collected by the camera. Herein, position-orientation information of another calibration plate in the plurality of first images is different from each other. In the embodiment of the present disclosure, the first image refers to an image used to calibrate the intrinsic parameter of the camera.

In the embodiment of the present disclosure, another calibration plate can be the same as or different from the calibration plate in the common field of view of the radar and the camera. This means that, in the embodiment of the present disclosure, another calibration plate used to calibrate the intrinsic parameter of the camera can be the same as or different from the calibration plate used to calibrate the target extrinsic parameter between the camera and the radar. Herein, the same calibration plate means that the same calibration plates are used to implement two calibration processes, namely, the calibration of the intrinsic parameter of the camera and the calibration of the target extrinsic parameter between the camera and the radar. In the above two calibration processes, the position-orientation information of the same calibration plate can be same or different, which is not limited here. However, different calibration plates can also be used to implement the calibration of the above two calibration processes. Here, different calibration plates used in the two calibration processes can mean that completely different or partially different calibration plates are used to realize the functions of the two calibration plates respectively.

In the process of collecting the first images by the camera, another calibration plate can be in a static state. For example, a bracket can be used to fix another calibration plate.

In the case that the first images are collected by the camera, in order to improve the accuracy of calibrating the intrinsic parameter of the camera, the calibration plate (that is, another calibration plate used to calibrate the intrinsic parameter of the camera) can be placed as close as possible to an edge of the field of view of the camera, so that the ratio occupied by the calibration plate in the first image is greater than a preset value among the plurality of first images collected by the camera. In an implementation, the preset value can be a specific numerical value or a range value. It should be noted that the size of the preset value often affects the accuracy of the calibration of the intrinsic parameter of the camera. When the preset value is a specific numerical value, the larger the size of the preset value is, the higher the ratio of the calibration plate in the first image used to calibrate the intrinsic parameter of the camera, the more the state of the calibration plate in the image is affected by image distortion, and the effect of the distortion parameter can be fully considered in the calibration process of the intrinsic parameter of the camera. Taking the preset value being a range value as an example, the size of the range of the preset value will affect the accuracy of each intrinsic parameter of the camera determined based on each first image, and the final intrinsic parameter of the camera is determined based on each of the above intrinsic parameters of the camera. Therefore, in order to improve the accuracy of the intrinsic parameter of the camera obtained later, the preset value can be set to a value between [0.8, 1]. For example, in the image shown in FIG. 6, the ratio of the calibration plate in the entire image is within a range of the preset value, so this image can be taken as the first image.

In order to improve the accuracy of the determined intrinsic parameter of the camera, the number of the first images collected by the camera may be multiple, for example, more than 20. In the embodiment of the present disclosure, the position-orientation information of the calibration plate in the collected plurality of first images may be different, that is, there are at least some images in the plurality of first images that respectively show the different position-orientations of the calibration plate, for example, there are orientation changes in at least one of three dimensions of a pitch angle, a roll angle, and a yaw angle. This means that the plurality of first images can be collected when the calibration plate is in different positions and/or orientations, that is, the position-orientation information of the calibration plate included in different first images may be same or different, and there are at least two first images including different position-orientation information of the calibration plate. Here, each first image needs to include a complete calibration plate.

In addition, in the process of collecting the first images by the camera, the calibration plate can be in a static state. For example, a bracket can be used to fix another calibration plate.

In order to improve the accuracy of the first intrinsic parameter of the camera, the plurality of first images collected by the camera should not include a blurred image. Herein, the blurred image may be caused by movement of the sensor, that is, relative movement between the camera and the second calibration plate caused by the movement of the camera. In an implementation, the blurred image can be filtered out through a preset script.

In the embodiment of the present disclosure, a preset matlab toolbox can be used to respectively calibrate the plurality of candidate intrinsic parameters of the camera according to the plurality of first images. Generally, one first image can be used to calibrate one candidate intrinsic parameter of the camera. For each of the plurality of candidate intrinsic parameters, the camera can reproject a preset point in the camera coordinate system to the pixel coordinate system to obtain the corresponding projection point, and then compare the projection point and the observed preset point in the pixel coordinate system to obtain an error of the preset point. The errors obtained by comparing the respective candidate intrinsic parameters, and the candidate intrinsic parameter with the smallest error value is taken as the intrinsic parameter of the camera. In the embodiment of the present disclosure, the error generally refers to a distance between the projection point and the preset point in the pixel coordinate system, and the error value refers to the value of the distance.

For example, as shown in FIG. 7A, a preset point P in a 3D space is projected into the 2D space to obtain the corresponding first coordinate value P1. In addition, the actual second coordinate value of the preset point in the pixel coordinate system can be determined according to the collected image. For example, the second coordinate value shown in FIG. 7B is P2. For each candidate intrinsic parameter, the first coordinate value P1 corresponding to the second coordinate value P2 is determined, and a plurality of sets of coordinate pairs with corresponding relationships can be obtained. For example, P2 corresponds to P1, and P1 and P2 constitute a coordinate pair. For another example. P2′ corresponds to P1′, then P1′ and P2′ constitute another coordinate pair.

In the embodiment of the present disclosure, the distance between the first coordinate value and the second coordinate value in each set of coordinate pairs can be calculated respectively. A candidate intrinsic parameter corresponding to the smallest distance can be taken as the intrinsic parameter of the camera.

In the embodiment of the present disclosure, after the intrinsic parameter of the camera is calibrated according to the above method, when calibrating the sensor, the intrinsic parameter of the camera previously calibrated can be directly obtained, and the intrinsic parameter of the camera are used to perform de-distortion on the plurality of images of the calibration plate in different position-orientations which are collected by the camera. The plurality of images here are the images collected by the camera in step 101 above (that is, the images used together with the radar point cloud data to implement the calibration of the target extrinsic parameter between the camera and the radar). After de-distorting the plurality of images, a plurality of second images are obtained. According to the plurality of second images, the ideal intrinsic parameter of the camera is obtained, that is, the intrinsic parameter of the camera without distortion. Then an extrinsic parameter of the calibration plate relative to the camera is determined according to the ideal intrinsic parameter of the camera. It can be seen that in the process of calibrating the target extrinsic parameter between the camera and the radar, through the pre-determined intrinsic parameter of the camera, the images needed to implement calibration of the target extrinsic parameter are de-distorted, to obtain the extrinsic parameter of the calibration plate relative to the camera based on the second images resulted from the de-distortion.

Here, the intrinsic parameter of the camera. can be represented by an intrinsic parameter matrix A′, as shown in Equation 1:

$${A}^{′} = [ \begin{matrix}\frac{f}{{S}_{x}} & r & {u}_{0} \\ 0 & \frac{f}{{S}_{y}} & {v}_{0} \\ 0 & 0 & 1\end{matrix} ] \qquad Equation 1$$

wherein the meaning of each parameter can refer to the above description of camera parameter.

The process of performing de-distortion processing on the plurality of images is to ignore the influence of a distance value r of the pixel from the center of the imager due to distortion in the above intrinsic parameter matrix A′, so that r is as zero as possible. The intrinsic parameter matrix A ignoring the influence of the distortion can be expressed by Equation 2:

$$A = [ \begin{matrix}\frac{f}{{S}_{x}} & 0 & {u}_{0} \\ 0 & \frac{f}{{S}_{y}} & {v}_{0} \\ 0 & 0 & 1\end{matrix} ] \qquad Equation 2$$

In this way, a plurality of second images can be obtained according to the plurality of images after de-distortion, to determine the ideal intrinsic parameter of the camera. The preset matlab toolbox can be used to determine a plurality of candidate ideal intrinsic parameters of the camera respectively according to the plurality of second images after the distortion processing (normally, one candidate ideal intrinsic parameter of the camera can be determined according to one second image). The camera uses different candidate ideal intrinsic parameters to project a preset point in the camera coordinate system to the pixel coordinate system, to obtain a plurality of third coordinate values. By determining an actual position, i.e. a fourth coordinate value, of each preset point in the pixel coordinate system, and then taking the fourth coordinate value and the corresponding third coordinate value as a coordinate pair that have a corresponding relationship, a candidate ideal intrinsic parameter corresponding to the smallest distance in the plurality of coordinate pairs is taken as the second intrinsic parameter of the camera.

Then, a homography matrix H corresponding to each second image can be first calculated, to obtain a plurality of homography matrices H, and then extrinsic parameters of the calibration plate in different position-orientations relative to the camera are calculated based on the ideal intrinsic parameter and the plurality of homography matrices. Here, the homography matrix is a matrix describing the positional mapping relationship between the world coordinate system and the pixel coordinate system.

In the embodiment of the present disclosure, the homography matrix H corresponding to each second image can be calculated in the following manner:

$$s = [ \begin{matrix}u \\ v \\ 1\end{matrix} ] = A [ \begin{matrix}{r}_{1} & {r}_{2} & {r}_{3} & t\end{matrix} ] [ \begin{matrix}X \\ Y \\ 0 \\ 1\end{matrix} ] = A [ \begin{matrix}{r}_{1} & {r}_{2} & t\end{matrix} ] [ \begin{matrix}X \\ Y \\ 1\end{matrix} ] \qquad Equation 3$$

$$H = A [ \begin{matrix}{r}_{1} & {r}_{2} & t\end{matrix} ] \qquad Equation 4$$

wherein r₁, r₂ and r₃ are rotation column vectors that make up the rotation matrix R, the dimension is 1×3, and t is a vector form of the translation matrix T.

According to Equation 3 and Equation 4, Equation 5 can be obtained:

$$s [ \begin{matrix}u \\ v \\ 1\end{matrix} ] = H [ \begin{matrix}X \\ Y \\ 1\end{matrix} ] \qquad Equation 5$$

wherein (u, v) is a pixel coordinate, (X, Y) corresponds to the coordinate of the calibration plate, and s is a scale factor.

In the embodiment of the present disclosure, the homography matrix H corresponding to the plurality of second images can be calculated by Equation 5.

After obtaining a plurality of homography matrices H through calculation, in the case of determining the extrinsic parameters R and T of the calibration plate in different position-orientation information relative to the camera, the Equation 4 can be used for calculation. Here, the homography matrix H is a 3×3 matrix, and Equation 4 can be further expressed as:

[h₁ h₂ h₃]=λA[r₁ r₂ t] Equation 6

where λ represents a scale factor.

r₁=λA⁻¹h₁, r₂=λA⁻¹h₂, r₃=r₁×r₂ can be obtained through calculation, where λ=1/∥A⁻¹h₁∥=1/∥A⁻¹h₂, and r1, r2 and r3 constitute a 3×3 rotation matrix R.

According to Equation 6, it can be calculated t=λA⁻¹h₃, where t forms a 3×1 translation matrix T.

In the embodiment of the present disclosure, the candidate intrinsic parameters of the camera are a plurality of candidate intrinsic parameters of the camera which are determined according to the plurality of first images of the calibration plate containing different position-orientation information which are collected by the camera. The candidate intrinsic parameters are determined in the above manner, that is, the candidate intrinsic parameter with the smallest error value between the projection point and the corresponding point in the pixel coordinate system is determined as the intrinsic parameter of the camera which is obtained by calibrating the sensor. After the intrinsic parameter of the camera is calibrated, when the sensor is to be calibrated again, the intrinsic parameter of the camera previously calibrated can be directly obtained. The subsequent ideal intrinsic parameter of the camera is an intrinsic parameter of the camera in an ideal state without distortion, and is determined based on a plurality second images resulted from de-distortion on the plurality of images of the calibration plate including different position-orientation information which is collected by the camera.

In addition, in the embodiment of the present disclosure, in addition to the intrinsic parameter of the camera, the extrinsic parameter of the calibration plate relative to the camera is also involved, which is determined from the ideal intrinsic parameter of the camera and the plurality of second images, that is, the ideal intrinsic parameter of the camera after de-distortion and the plurality of second images after de-distortion. The target extrinsic parameter, that is, the extrinsic parameter between the radar and the camera, is determined based on the extrinsic parameter of the calibration plate relative to the camera and the plurality of sets of target radar point cloud data. They are used to reflect changes in parameters such as the position and orientation of the radar coordinate system relative to the camera coordinate system.

In step 103-2, for the calibration plate in each of the respective position-orientations, a set of target radar point cloud data matched with the calibration plate in the position-orientation among the multiple sets of radar point cloud data is determined according to the extrinsic parameter of the calibration plate relative to the camera and an extrinsic parameter reference value between the radar and the camera.

Here, the extrinsic parameter reference value can be a rough estimated extrinsic parameter value between the radar and the camera based on an approximate position and orientation between the radar and the camera. The radar coordinate system can be superimposed with the camera coordinate system through operations such as translation and rotation of the radar coordinate system according to the extrinsic parameter reference value.

In the embodiment of the present disclosure, for the calibration plate in each position-orientation, a target plane where the calibration plate is located can be determined with an M-estimator SAmple Consensus (MSAC) algorithm according to the extrinsic parameter of the calibration plate relative to the camera and the extrinsic parameter reference value between the radar and the camera. Further, a MeanShift (MeanShift) clustering algorithm can be used on the target plane to determine the target radar point cloud data matched with the calibration plate from the corresponding radar point cloud data.

In the embodiment, the intrinsic parameter of the camera calibrated in advance can be obtained, and the extrinsic parameters of the calibration plate relative to the camera in different position-orientations can be determined according to the intrinsic parameter and the plurality of images collected by the camera previously. For the calibration plate in each position-orientation, according to the extrinsic parameter of the calibration plate relative to the camera and the reference value of the extrinsic parameter between the radar and the camera, a set of target radar point cloud data matched with the calibration plate in the position-orientation is determined from a set of corresponding radar point cloud data. The purpose of automatically determining the target radar point cloud data matched with the calibration plate in the radar point cloud data can be realized.

In some optional embodiments, for example, as shown in FIG. 8, for a certain position-orientation, the above step 103-2 can include the following steps.

In step 103-21, a candidate position of the calibration plate in the position-orientation among the multiple sets of radar point cloud data is determined according to the extrinsic parameter of the calibration plate relative to the camera and an extrinsic parameter reference value between the radar and the camera.

In the embodiment of the present disclosure, the position where the calibration plate is located is estimated in the radar point cloud data collected for the calibration plate, according to the extrinsic parameter of the calibration plate in the position-orientation relative to the camera and the estimated extrinsic parameter reference value between the radar and the camera, to obtain an approximate position-orientation of the calibration plate. The approximate position-orientation where the calibration plate is located is taken as a candidate position. The candidate position represents an approximate position of the calibration plate in a map composed of radar point cloud data.

In step 103-22, a target plane where the calibration plate is located in the position-orientation among the multiple sets of radar point cloud data is determined according to the candidate position.

In the embodiment of the present disclosure, from a set of radar point cloud data collected in the position-orientation, the plurality of first radar points located in the area corresponding to the candidate position can be selected, and a first plane composed of the plurality of radar points can be obtained. Here, the process of selecting the plurality of first radar points can be performed randomly or according to a preset rule. In the embodiment of the present application, a random selection method can be used to determine the plurality of first radar points in an area corresponding to the candidate position. Such selection is repeated for several times to obtain a plurality of first planes.

For each of the plurality of first planes, distances from other radar points in each set of radar point cloud data than the first radar point to the first plane are respectively calculated. Radar points having a distance less than a preset threshold among other radar points are taken as the second radar points, and the second radar points are determined as the radar points in the first plane. The first plane with the largest number of radar points is taken as the target plane where the calibration plate is located. A value of the preset threshold can be preset, and in the embodiment of the present application, the value of the preset threshold is not limited. The target plane represents the plane on which the calibration plate is located in a map composed of radar point cloud data.

In step 103-23, the set of target radar point cloud data matched with the calibration plate in the position-orientation on the target plane corresponding to the multiple sets of radar point cloud data is determined.

On each target plane, a first circular area is randomly determined according to the size of the calibration plate. The initial first circular area can be the area corresponding to the circumscribed circle of the calibration plate. In each set of the radar point cloud data, a radar point located in the initial first circular area is selected as a first center of the first circular area to adjust the position of the first circular area in the in the radar point cloud data. Here, the method of selecting a radar point located in the first circular area can be random or performed according to a certain preset rule. In the embodiment of the present application, the method of randomly selecting can be used to determine a radar point located in the first circular area. The size of the calibration plate is the size of the calibration plate in a map composed of radar point cloud data.

Taking the first circle center as the starting point, and a plurality of third radar points located in the first circular area in the radar point cloud data as ending points, a plurality of first vectors are obtained respectively. A second vector is obtained by adding the plurality of first vectors. Based on the second vector, a target center position of the calibration plate is determined. Here, the target center position of the calibration plate is the determined center position of the calibration plate in a map composed of radar point cloud data.

Further, according to the target center position of the calibration plate and the size of the calibration plate, a set of target radar point cloud data matching the calibration plate is determined in the radar point cloud data.

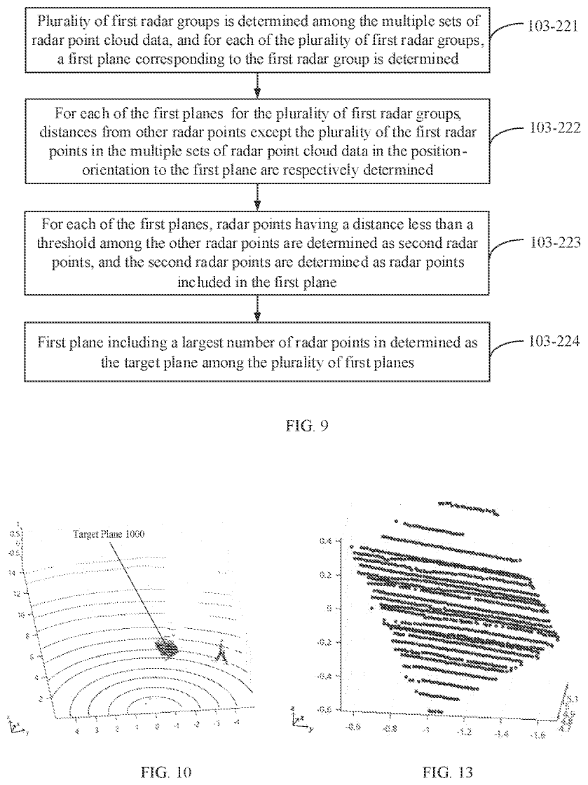

In some optional embodiments, for example, as shown in FIG. 9, step 103-22 can include the following steps.

In step 103-221, a plurality of first radar groups is determined among the multiple sets of radar point cloud data, and for each of the plurality of first radar groups, a first plane corresponding to the first radar group is determined, wherein each of the plurality of first radar groups includes a plurality of first radar points randomly selected and located in an area corresponding to the candidate position, and the first plane corresponding to the first radar group includes a plurality of first radar points of the first radar group.

In the embodiment of the present disclosure, a plurality of first radar points located in the area corresponding to the candidate position can be randomly selected from the radar point cloud data corresponding to a certain position-orientation each time to obtain a first radar group, and then a first plane composed of a plurality of first radar points of the first radar group can be obtained each time. If the plurality of first radar points are randomly selected in a plurality of times, a plurality of first planes can be obtained.

Herein, each first radar group includes a plurality of first radar points, and parts of the plurality of first radar points included in different first radar groups are same or different.

For example, assuming that the radar points include 1, 2, 3, 4, 5. 6, 7 and 8, the first radar points 1, 2, 3, and 4 are randomly selected to form a first plane 1 for the first time, and the first radar points 1, 2, 4, and 6 are randomly selected to form a first plane 2 for the second time, and the first radar points 2, 6, 7 and 8 are randomly selected to form a first plane 3 for the third time.

In step 103-222, for each of the first planes for the plurality of first radar groups, distances from other radar points except the plurality of the first radar points in the multiple sets of radar point cloud data in the position-orientation to the first plane are respectively determined.

For example, for the first plane 1, the distances from other radar points 5, 6, 7, and 8 to the first plane 1 can be calculated; for the first plane 2, the distances from other radar points 3, 5, 7, and 8 to the first plane 2 can be calculated; and similarly, for the first plane 3, the distances from other radar points 1, 3, 4. and 5 to the first plane 3 can be calculated.

In step 103-223, for each of the first planes, radar points having a distance less than a threshold among the other radar points are determined as second radar points, and the second radar points are determined as radar points included in the first plane.

For example, assuming that for the first plane 1, the distance from other radar point 5 to the first plane 1 is less than the preset threshold, then radar point 5 is taken as the second radar point, and finally the first plane 1 includes radar point 1, 2, 3, 4, and 5. Similarly, it can be assumed that the first plane 2 includes radar points 1, 2, 4, 6, and 7, and it can be assumed that the first plane 3 includes radar points 1, 3, 4, 5, 6, 8.

In step 103-224, a first plane including a largest number of radar points in determined as the target plane among the plurality of first planes.

A first plane with the largest number of radar points, such as the first plane 3, is determined as a target plane where the calibration plate is located. FIG. 10 is a schematic diagram of a target plane 1000 in an image composed of radar point cloud data. Units of xyz coordinate axes are all meters, and coordinate axes in FIG. 10 are just examples. In practical applications, the xyz coordinate axes can point in different directions.

For each set of radar point cloud data, the above method can be used to determine a target plane of the calibration plate in the image composed of radar point cloud data.

In the above embodiment, through the M estimation algorithm in the above process, a more accurate target plane can be fitted, and the usability thereof is high.

In some optional implementations, for example, as shown in FIG. 11, step 103-23 can include the following steps.

In step 103-231, an initial first circular area is determined according to a size of the calibration plate on the target plane.

In the embodiment of the present disclosure, after the target plane where the calibration plate is located is determined, the initial first circular area can be determined on the target plane according to the size of the calibration plate. The size can be the size of the circumscribed circle of the calibration plate. Here, the size of the calibration plate is the size of the calibration plate in the map composed of radar point cloud data.

In step 103-232, a radar point located in the initial first circular area is selected among the multiple sets of radar point cloud data as a first center of a first circular area to determine a position of the first circular area in the multiple sets of radar point cloud data.

In the embodiment of the present disclosure, after the initial first circular area is determined, a radar point is randomly selected from the radar point cloud data in the initial first circular area as the first circle center of the first circular area. The position of the first circular area in the radar point cloud data is subsequently adjusted through the first circle center. The radius of the first circular area is the same as that of the initial first circular area.

In step 103-233, a plurality of first vectors are respectively obtained by taking the first circle center as a starting point and a plurality of third radar points located in the first circular area in the multiple sets of radar point cloud data as ending points.

In the embodiment of the present disclosure, as shown in FIG. 12, for example, the first circle center 120 can be taken as the starting point, and the plurality of third radar points 121 located in the first circular area in the radar point cloud data can be taken as the ending points, so that the plurality of first vectors 122 can be obtained.

In some examples, the third radar points 121 can effectively cover a circular area, as shown in FIG. 12.

In step 103-234, the plurality of first vectors are added to obtain a second vector.

In the embodiment of the present disclosure, a Meanshift vector, that is, a second vector, can be obtained by adding all the first vectors.

In step 103-235, a target center position of the calibration plate is determined based on the second vector.

In the embodiment of the present disclosure, the ending point of the second vector is taken as the second circle center, and the second circular area is obtained according to the size of the calibration plate. A plurality of fourth radar points in the second circular area are taken as the ending points and the second circle center is taken as the starting point, a plurality of third vectors are obtained respectively. The plurality of third vectors are added to obtain a fourth vector, and then the ending point of the fourth vector is taken as a new second circle center to obtain a new second circular area. The above steps are repeated to determine the fourth vector until the fourth vector converges to a preset value, and the corresponding second circle center at this time is taken as the candidate center position of the calibration plate. The candidate center position is the candidate center position of the calibration plate in the map composed of the radar point cloud data.

It can be determined whether the candidate center position coincides with the center position of the calibration plate. If the candidate center position coincides with the center position of the calibration plate, the candidate center position can be directly taken as the target center position; otherwise, the new candidate center position can be re-determined until the final target center position is determined.

In step 103-236, the set of target radar point cloud data matched with the calibration plate is determined among the multiple sets of radar point cloud data according to the target center position of the calibration plate and the size of the calibration plate.

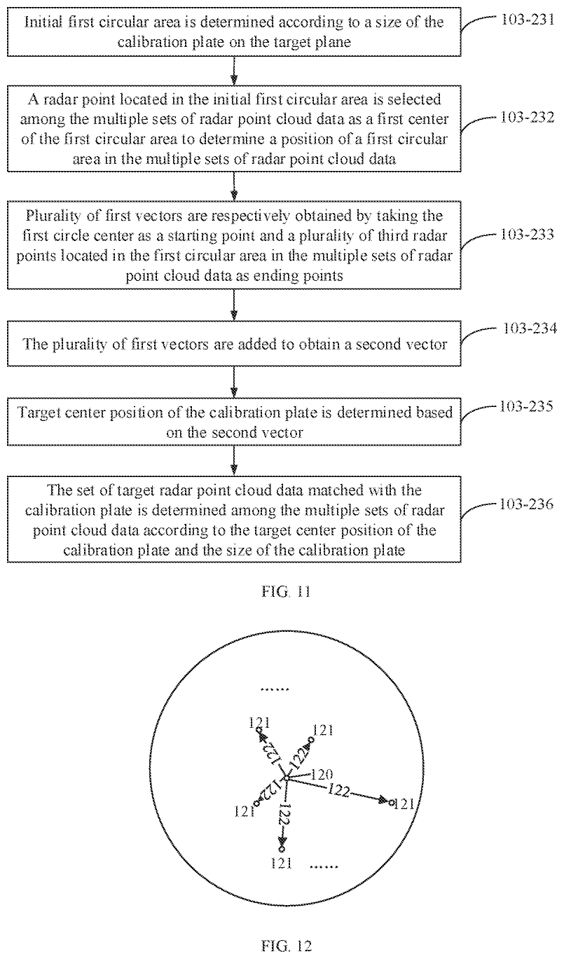

In the embodiment of the present disclosure, after the target center position of the calibration plate is determined, a corresponding position of the calibration plate can be determined according to the target center position and size of the calibration plate. A calibration plate matches the position of the calibration plate in the radar point cloud data can be taken as the target radar point cloud data. Each point in FIG. 13 is a schematic diagram of the target radar point cloud data. The units of the xyz coordinate axes are all meters, and the coordinate axes in the figure are just examples. In practical applications, the xyz coordinate axes can point in different directions.

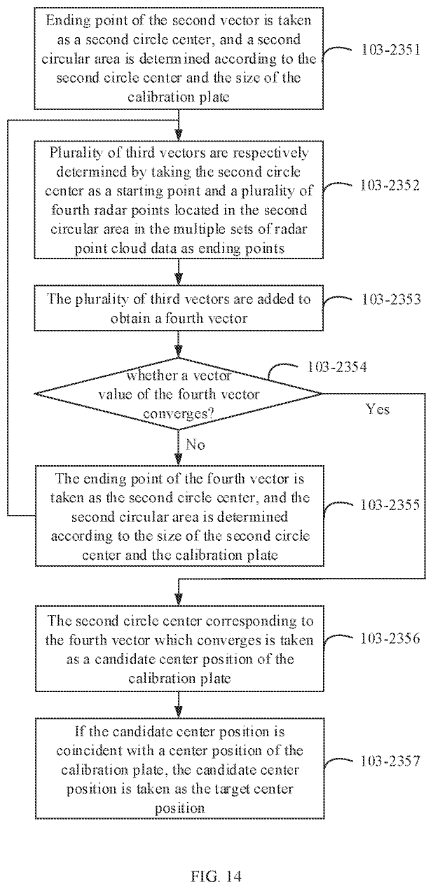

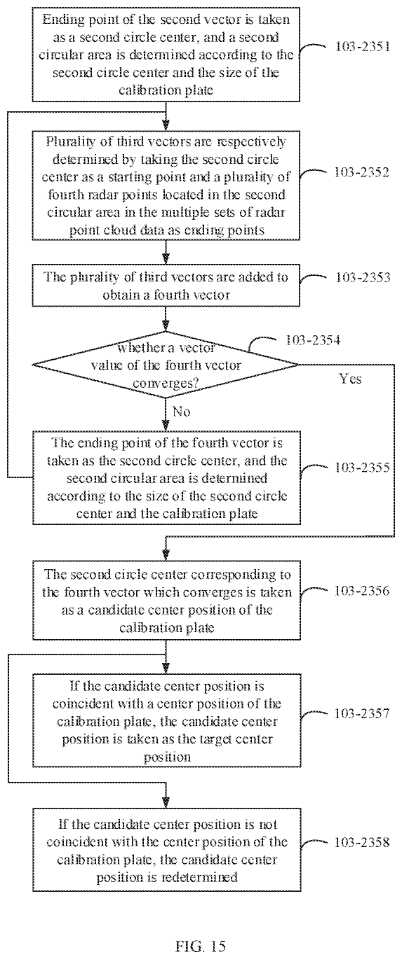

In some optional implementations, for example, as shown in FIG. 14, step 103-235 can include the following steps.

In step 103-2351, an ending point of the second vector is taken as a second circle center, and a second circular area is determined according to the second circle center and the size of the calibration plate.

In the embodiment of the present disclosure, the ending point of the second vector can be determined as the second circle center, and then the second circle center can be taken as the new circle center, and the radius is the radius of the circumscribed circle of the calibration plate to obtain the second circular area.

In step 103-2352, a plurality of third vectors are respectively determined by taking the second circle center as a starting point and a plurality of fourth radar points located in the second circular area in the multiple sets of radar point cloud data as ending points.

In the embodiment of the present disclosure, the second circle center is taken as the starting point, and the plurality of fourth radar points located in the second circle center area in the radar point cloud data are taken as the ending points, so that the plurality of third vectors are obtained respectively.

In step 103-2353, the plurality of third vectors are added to obtain a fourth vector.

In step 103-2354, it is determined whether a vector value of the fourth vector converges to a preset value.

If the vector value of the fourth vector converges to the preset value, jump to step 103-2356; and if the vector value of the fourth vector does not converge to the preset value, jump to step 103-2355. Alternatively, the preset value can be close to zero.

In step 103-2355, the ending point of the fourth vector is taken as the second circle center, and the second circular area is determined according to the size of the second circle center and the calibration plate, and then jump to step 103-2352.

In the embodiment of the present disclosure, the ending point of the fourth vector can be redetermined as the new second circle center, and a new fourth vector can be calculated again according to the above steps 103-2352 to 103-2354, and it can be determined whether the vector value of the fourth vector is converged. The above process is repeated continuously until the finally obtained vector value of the fourth vector converges to the preset value.

In step 103-2356, the second circle center corresponding to the fourth vector which converges is taken as a candidate center position of the calibration plate.

In the embodiment of the present disclosure, in the case that the vector value of the fourth vector converges to the preset value, the second circle center corresponding to the fourth vector can be taken as a candidate center position of the calibration plate.

In step 103-2357, if the candidate center position is coincident with a center position of the calibration plate, the candidate center position is taken as the target center position.

In the embodiment of the present disclosure, it can be determined whether the candidate center position overlaps with the center position of the calibration plate in the map composed of radar point cloud data. If the candidate center position overlaps with the center position of the calibration plate, the candidate center position is taken as the final target center position of the calibration plate.

In some optional implementations, such as shown in FIG. 19, step 103-235 can further include the following steps.

In step 103-2358, if the candidate center position is not coincident with the center position of the calibration plate, the candidate center position is redetermined.

In the case that the candidate center position does not coincide with an actual center position of the calibration plate, all radar points in the second circular area can be deleted, and a new second circular area can be redetermined. Alternatively, the set of radar point cloud data is directly deleted and the candidate center position of the calibration plate is redetermined according to another set of radar point cloud data corresponding to other attitudes of the calibration plate until the determined candidate center position coincides with the center position of the calibration plate.

At this time, step 103-2357 is performed again, and the candidate center position is taken as the target center position corresponding to the current target attitude of the calibration plate.

In the above embodiments, by using the mean shift algorithm to determine the target radar point cloud data matched with the calibration plate on the target plane, the purpose of determining the target radar point cloud data matched with the calibration plate in the radar point cloud data can be realized.

In some optional implementations, each of the multiple sets of corresponding relationships includes a plurality of corresponding relationships, and parts of the plurality of corresponding relationships included in different sets of corresponding relationships are same or different.

For example, a first set of the plurality of corresponding relationships includes three corresponding relationships, namely, image 1 corresponds to radar point cloud data 1, image 2 corresponds to radar point cloud data 2 and image 3 corresponds to radar point cloud data 3; and a second set of the plurality of corresponding relationships includes four corresponding relationships, namely, image 1 corresponds to radar point cloud data 1, image 2 corresponds to radar point cloud data 2, image 5 corresponds to radar point cloud data 5 and image 6 corresponds to radar point cloud data 6.

Correspondingly, step 104 can include respectively determining a plurality of candidate extrinsic parameters between the radar and the camera according to the multiple sets of target radar point cloud data and the multiple sets of corresponding relationships; and determining the target extrinsic parameter between the radar and the camera according to the plurality of candidate extrinsic parameters.

In the embodiment of the present disclosure, for each of the multiple sets of corresponding relationships, from the multiple sets of target radar point cloud data associated with the set of corresponding relationships, a least squares method can be used to minimize the sum of squares of errors extrinsic parameter between the radar and the cameras, to determine a candidate extrinsic parameter.

For example, the plurality of corresponding relationships can include: image 1 corresponds to radar point cloud data 1, image 2 corresponds to radar point cloud data 2, . . . , image n corresponds to radar point cloud data n, wherein n is an integer greater than or equal to 2. A set of target radar point cloud data matched with the calibration plate in radar point cloud data 1 is target radar point cloud data 1. Similarly, a set of target radar point cloud data matching the calibration plate in radar point cloud data n is target radar point cloud data n. According to multiple sets of target radar point cloud data, for example, for a certain set of corresponding relationships, which includes the first 3 corresponding relationships, based on the target radar point cloud data 1, 2 and 3, and these three corresponding relationships, the least square method can be used to determine a candidate extrinsic parameter between the radar and the camera. For another example, for another set of corresponding relationships, which includes the first 4 corresponding relationships, and based on the target radar point cloud data 1, 2, 3, and 4, and these four corresponding relationships, a candidate extrinsic parameter between the radar and the camera can be determined. Using the above method, a plurality of sets of target radar point cloud data in different combinations and corresponding relationships can be used to determine a plurality of candidate extrinsic parameters between the radar and the camera.

In some examples, in order to better obtain candidate extrinsic parameters, in a set of corresponding relationships, the position-orientation information of the involved images is different. For example, if a certain set of corresponding relationships includes the first three corresponding relationships, the position-orientation information of image 1, image 2 and image 3 are different from each other.

It should be noted that the reference number of the above-mentioned radar point cloud data is only used to distinguish a plurality of sets of radar point cloud data. Similarly, the reference number of the above-mentioned images is only used to distinguish a plurality of images. In the embodiment of the present application, a plurality of sets of data used to determine the candidate extrinsic parameters can be obtained according to the order of collecting the images and generating the radar point cloud data, and the data sets used to determine the candidate extrinsic parameters can also be randomly selected from the plurality of sets of corresponding relationships collected. The implementation provided above for determining the plurality of candidate extrinsic parameters between the radar and the camera is only an example, and is not intended as a limitation to the embodiment of the present application.

Among the plurality of candidate extrinsic parameters determined above, a candidate extrinsic parameter with the best projection effect is determined as the target extrinsic parameter between the radar and the camera.

In the embodiment, the candidate extrinsic parameters between the radar and the camera can be determined based on the multiple sets of target radar cloud data and the multiple sets of corresponding relationships, and a target extrinsic parameter is determined based on the plurality of candidate extrinsic parameters. Through the above process, the accuracy of the target extrinsic parameter between the radar and the camera can be improved.

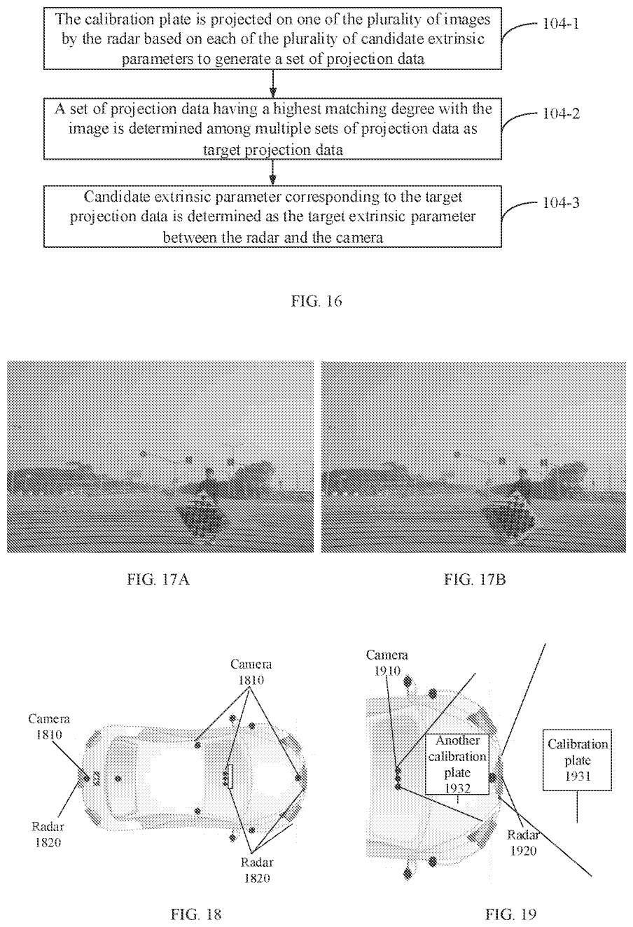

In some optional implementations, for example, as shown in FIG. 16, step 104 can further include the following steps.

In step 104-1, the calibration plate is projected on one of the plurality of images by the radar based on each of the plurality of candidate extrinsic parameters to generate a set of projection data.

In the camera coordinate system, the candidate extrinsic parameter between the radar and the camera, the matrix of the intrinsic parameter of the camera and the radar point cloud data can be multiplied to project the radar point cloud data to a certain image, and then a set of projection data can be obtained, for example, as shown in FIG. 17A. The radar point cloud data can be a set of the multiple sets of radar point cloud data collected before, or can be radar point cloud data newly collected. For better subsequent comparison, the calibration plate needs to be included in the collected target.

In step 104-2, a set of projection data having a highest matching degree with the image is determined among multiple sets of projection data as target projection data.

Among the multiple sets of projection data, a set of projection data having the highest degree with the image is determined, and then the set of projection data is determined as target projection data. For example, the two sets of projection data are respectively projected on the corresponding images to obtain the projection data, for example, as shown in FIG. 17A and FIG. 17B, wherein the projection effect of FIG. 17A is better than that of FIG. 17B, and thus the projection data corresponding to FIG. 17A is the target projection data.

In step 104-3, a candidate extrinsic parameter corresponding to the target projection data is determined as the target extrinsic parameter between the radar and the camera.

A candidate extrinsic parameter corresponding to the target projection data is the target extrinsic parameter between the radar and the camera.

In the above embodiment, the calibration plate can be projected by radar based on each candidate external parameter, and a set of candidate external parameters corresponding to the projection data with the best projection effect can be used as the target external parameters between the radar and the camera, thereby improving the accuracy of the target extrinsic parameter between the radar and the camera.

In some optional embodiments, the radar and the camera can be deployed on a vehicle, and the radar can be a lidar. Optionally, the radar and the camera can be deployed at different positions of the vehicle. For example, as shown in FIG. 18, a radar 1820 and a camera 1810 can be deployed in the front and the rear of the vehicle, the front windshield, etc.

Since the movement of the vehicle causes at least one of the orientations of the radar and the camera to change, the camera can automatically collect a plurality of images of the calibration plate in different position-orientations disposed in the common field of view, and the radar can generate a plurality of sets of radar point cloud data of the calibration plate in corresponding position-orientations. Among the plurality of sets of radar point cloud data, a plurality of sets of target radar point cloud data matched with the calibration plate are automatically determined. According to the plurality of sets of target radar point cloud data and the plurality of sets of corresponding relationships between the images and the radar point cloud data, the target extrinsic parameter between the radar and the camera is determined.

The target extrinsic parameter obtained through the above process can be more accurate. Further, vehicle positioning, measure the distance to other vehicles or pedestrians, etc., can be better realized, thereby improving driving safety and having better usability.

In some optional implementations, the plurality of images include a complete calibration plate, and the multiple sets of radar point cloud data include point cloud data obtained based on the complete calibration plate.

In the embodiment, the accuracy of the target extrinsic parameter between the radar and the camera can be finally ensured.

The above-mentioned methods provided by the embodiment of the present disclosure can be used on a machinery device, which can be manually driven or unmanned vehicles, such as airplanes, vehicles, drones, unmanned vehicles, and robots, etc. Taking a vehicle as an example, the radar can be provided at the position of the front bumper, and the camera can be provided at the position of the rearview mirror, as shown in FIG. 19, for example. The calibration plate 1931 is disposed in the common field of view of the radar 1920 and the camera 1910, and the calibration plate 1931 can be fixed on the ground or held by the staff

Taking the camera 1910 and radar 1920 deployed on the vehicle as an example, the vertical distance between the camera 1910 and the ground is usually different from the vertical distance between the radar 1920 and the ground. When the calibration plate 1931 is deployed in the right front of the vehicle, the horizontal distance between the camera 1910 and the calibration plate 1931 is greater than the horizontal distance between the radar 1920 and the calibration plate 1931. It can be seen that in order to ensure that the radar 1920 can generate radar point cloud data including target radar point cloud data, it is often necessary to deploy the calibration plate 1931 at a relatively far position in front of the radar 1920.

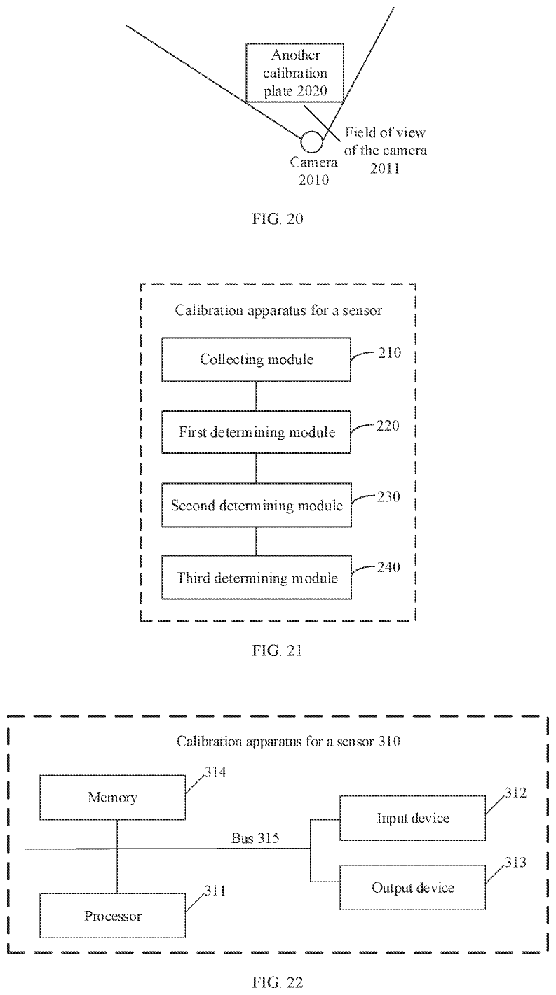

Since the distortion at the edge of the camera 2010 is relatively large, in order to better determine the distortion parameter in the intrinsic parameter of the camera 2010, another calibration plate 2020 can be placed close to the edge of the field of view 2011 of the camera, as shown in FIG. 20. The accuracy of the calibrated intrinsic parameter of the camera improves the accuracy of the final target extrinsic parameter between the radar and the camera. Therefore, in order to improve the calibration accuracy of the intrinsic parameter of the camera, it is often necessary to ensure that the distance between the other calibration plate and the camera is relatively close.

With the technical solution provided by the embodiment of this application, the calibration of the intrinsic parameter of the camera and the calibration of the target extrinsic parameter between the camera and the radar are effectively separated. That is, the two calibration processes using different images, it can ensure both the calibration accuracy of the intrinsic parameter of the camera and the calibration accuracy of the target extrinsic parameter between the camera and the radar as much as possible. In addition, in the second or more calibration process of the target extrinsic parameter between the camera and the radar, there is no need to calibrate the intrinsic parameter of the camera once more.

If a manual matching method in the related art is used to determine the target radar point cloud data in the radar point cloud data, not only the error is large, but the error caused by each time of matching will eventually be superimposed, thereby lowering the final accuracy of the target extrinsic parameter between the radar and the camera. In the embodiment of the present disclosure, the target radar point cloud data can be automatically determined, and then the target extrinsic parameter between the radar and the camera can be determined, which can improve the accuracy of the target extrinsic parameter between the radar and the camera.

Corresponding to the above method embodiments, the present disclosure also provides device embodiments.

As shown in FIG. 21, FIG. 21 is a block diagram showing a calibration apparatus for a sensor according to an exemplary embodiment of the present disclosure. The sensor includes a camera and a radar, and a calibration plate is located within a common field of view range of the radar and the camera. The apparatus includes: a collecting module 210 configured to collect a plurality of images of a calibration plate in respective position-orientations by the camera, and collect multiple sets of radar point cloud data of the calibration plate in the respective position-orientations by the radar; a first determining module 220 configured to establish corresponding relationships between the plurality of images and the multiple sets of radar point cloud data based on the respective position-orientations of the calibration plate, wherein, for each of the respective position-orientations of the calibration plate, a corresponding relationship exists between an image of the plurality of images and a set of the multiple sets of radar point cloud data that are collected in the respective position-orientation of the calibration plate; a second determining module 230 configured to respectively determine multiple sets of target radar point cloud data matched with the calibration plate in the respective position-orientations among the multiple sets of radar point cloud data; and a third determining module 240 configured to determine a target extrinsic parameter between the radar and the camera according to the multiple sets of target radar point cloud data and multiple sets of corresponding relationships.

In some optional implementations, the second determining module includes: a first determining sub-module configured to obtain an intrinsic parameter of the camera calibrated in advance, and respectively determine an extrinsic parameter of the calibration plate in each of the respective position-orientations relative to the camera according to the intrinsic parameter of the camera and the plurality of images; and a second determining sub-module configured to, for the calibration plate in each of the respective position-orientations, determine a set of target radar point cloud data matched with the calibration plate in the position-orientation among the multiple sets of radar point cloud data according to the extrinsic parameter of the calibration plate relative to the camera and an extrinsic parameter reference value between the radar and the camera.

In some optional implementations, the second determining sub-module includes: a first determining unit configured to determine a candidate position of the calibration plate in the position-orientation among the multiple sets of radar point cloud data according to the extrinsic parameter of the calibration plate relative to the camera and an extrinsic parameter reference value between the radar and the camera; a second determining unit configured to determine a target plane where the calibration plate is located in the position-orientation among the multiple sots of radar point cloud data according to the candidate position; and a third determining unit configured to determine the set of target radar point cloud data matched with the calibration plate in the position-orientation on the target plane corresponding to the multiple sets of radar point cloud data.

In some optional implementations, the second determining unit includes: a first determining sub-unit configured to determine a plurality of first radar groups among the multiple sets of radar point cloud data in the position-orientation, and for each of the plurality of first radar groups, determine a first plane corresponding to the first radar group, wherein each of the plurality of first radar groups includes a plurality of first radar points randomly selected and located in an area corresponding to the candidate position, and parts of the plurality of first radar points included in different first radar groups are same or different, and the first plane corresponding to the first radar group includes a plurality of first radar points of the first radar group; a second determining sub-unit configured to, for each of the first planes for the plurality of first radar groups, determine distances among other radar points except the plurality of the first radar points in the multiple sets of radar point cloud data in the position-orientation to the first plane; a third determining sub-unit configured to, for each of the first planes, determine radar points having a distance less than a threshold among the other radar points as second radar points, and determine the second radar points as radar points included in the first plane; and a fourth determining sub-unit configured to determine a first plane including a largest number of radar points as the target plane among the first planes.

In some optional implementations, the third determining unit includes: a fifth determining sub-unit configured to determine an initial first circular area according to a size of the calibration plate on the target plane; a sixth determining sub-unit configured to select a radar point located in the initial first circular area among the multiple sets of radar point cloud data as a first center of a first circular area to determine a position of the first circular area in the multiple sets of radar point cloud data; a seventh determining sub-unit configured to respectively obtain a plurality of first vectors by taking the first circle center as a starting point and a plurality of third radar points located in the first circular area in the multiple sets of radar point cloud data as ending points; an eighth determining sub-unit configured to add the plurality of first vectors to obtain a second vector; a ninth determining sub-unit configured to determine a target center position of the calibration plate based on the second vector; a tenth determining sub-unit configured to determine the set of target radar point cloud data matched with the calibration plate among the multiple sets of radar point cloud data according to the target center position of the calibration plate and the size of the calibration plate.

In some optional implementations, the ninth determining sub-unit is further configured to take an ending point of the second vector as a second circle center, and determine a second circular area according to the second circle center and the size of the calibration plate; respectively determine a plurality of third vectors by taking the second circle center as a starting point and a plurality of fourth radar points located in the second circular area in the multiple sets of radar point cloud data as ending points; add the plurality of third vectors to obtain a fourth vector; determine whether a vector value of the fourth vector converges to a preset value; in response to determining that the vector value of the fourth vector does not converge to the preset value, take an ending point of the fourth vector which does not converge as the second circle center, and redetermine the plurality of third vectors and the fourth vector; in response to determining that the vector value of the fourth vector converges to the preset value, take the second circle center corresponding to the fourth vector which converges as a candidate center position of the calibration plate; and if the candidate center position is coincident with a center position of the calibration plate, take the candidate center position as the target center position.

In some optional implementations, the ninth determining sub-unit is further configured to, if the candidate center position is not coincident with the center position of the calibration plate, redetermine the candidate center position.

In some optional implementations, each of the multiple sets of corresponding relationships includes a plurality of corresponding relationships, and parts of the plurality of corresponding relationships included in different sets of corresponding relationships are the same or different, the third determining module includes: a third determining sub-module configured to respectively determine a plurality of candidate extrinsic parameters between the radar and the camera according to the multiple sets of target radar point cloud data and the multiple sets of corresponding relationships; and determine the target extrinsic parameter between the radar and the camera according to the plurality of candidate extrinsic parameters.

In some optional implementations, the third determining sub-module includes: a generating unit configured to project the calibration plate on one of the plurality of images by the radar based on each of the plurality of candidate extrinsic parameters to generate a set of projection data to generate a set of projection data; a fourth determining unit configured to determine a set of projection data having a highest matching degree with the image among multiple sets of projection data as target projection data; and a fifth determining unit configured to determine a candidate extrinsic parameter corresponding to the target projection data as the target extrinsic parameter between the radar and the camera.

In some optional implementations, the radar and the camera are deployed on a vehicle.

In some optional implementations, the plurality of images include a complete calibration plate, and the multiple sets of radar point cloud data include point cloud data obtained based on the complete calibration plate.

In some optional implementations, the radar includes a lidar, and a laser line emitted by the lidar intersects a plane where the calibration plate is located.

In some optional implementations, the calibration plate in the respective position-orientations includes: a calibration plate which is different from at least one of a distance between the camera and the radar or an orientation in a horizontal direction.

Generally, the device embodiments correspond to the method embodiments, related details can be referred to part of the description of the method embodiments. The device embodiments described above are merely illustrative, where the units described as separate components may or may not be physically separated, and the components displayed as units may or may not be physical units. That is, the units may be located in one place, or distributed to multiple network units. Some or all of the modules can be selected according to actual needs to achieve the objectives of the solutions of the embodiments, which can be understood and implemented by those of ordinary skill in the art without inventive works.

An embodiment of the present disclosure further provides a computer readable storage medium storing a computer program. When being executed by a processor, the computer program causes the processor to implement the calibration method for a sensor provided in any one of the examples above. Herein, the computer readable storage medium can be a non-volatile storage medium.

In some optional embodiments, an embodiment of the present disclosure provides a computer program product including computer readable codes, when running on a device, the computer readable codes cause the device to execute instructions to implement the calibration method for a sensor provided in any one of the examples above.

In some optional embodiments, an embodiment of the present disclosure also provides another computer program product for storing computer readable instructions. When the instructions are executed, the computer executes the calibration method for a sensor provided in any one of the examples above.

The computer program product may be specifically realized by means of hardware, software or a combination thereof. In an optional embodiment, the computer program product is specifically embodied as a computer storage medium. In another optional embodiment, the computer program product is specifically embodied as software products, such as a Software Development Kit (SDK).

An embodiment of the present disclosure also provides a calibration apparatus for a sensor, wherein the sensor includes a camera and a radar, and a calibration plate is located within a common field of view range of the radar and the camera, the apparatus including: a processor; and a memory for storing executable instructions of the processor; wherein the processor is configured to invoke the executable instructions to implement the calibration method for a sensor provided in any one of the examples above.

FIG. 22 is a schematic diagram showing a hardware structure of a calibration apparatus for a sensor provided by an embodiment of the present disclosure. The sensor includes a camera and a radar, and a calibration plate is located within a common field of view range of the radar and the camera. The calibration apparatus for a sensor 310 includes a processor 311, and can also include an input device 312, an output device 313, a memory 314 and a bus 315. The input device 312, the output device 313, the memory 314 and the processor 311 are connected to each other through the bus 315.

The memory includes but is not limited to a random access memory (RAM), a read-only memory (ROM), an erasable programmable read only memory (EPROM), or a portable read-only memory (compact disc read-only memory, CD-ROM), which is used for related instructions and data.

The input device is used to input data and/or signals, and the output device is used to output data and/or signals. The output device and the input device can be independent devices or an integrated device.

The processor can include one or more processors, for example, including one or more central processing units (CPUs). In the case where the processor is a CPU, the CPU can be a single-core CPU, or can also be a multi-core CPU.

The processor is used to invoke the program code and data in the memory to execute the steps in the foregoing method embodiment. For details, reference can be made to the description in the method embodiment, which will not be repeated here.

It can be understood that FIG. 22 only shows a simplified design of a calibration apparatus for a sensor. In practical applications, the calibration apparatus for a sensor can also contain other necessary components, including but not limited to any number of input/output devices, processors, controllers, memories, etc., and all the devices for calibrating a sensor that can implement the embodiments of the present disclosure are all within the scope of protection of the present disclosure.

In some embodiments, the functions provided by or the modules included in the apparatuses provided in the embodiments of the present disclosure may be used to implement the methods described in the foregoing method embodiments. For specific implementations, reference may be made to the description in the method embodiments above. For the purpose of brevity, details are not described here repeatedly.

The embodiment of the present disclosure also provides a calibration system, including a camera, a radar and a calibration plate, wherein the calibration plate is located within a common field of view range of the camera and the radar, and position-orientation information of the calibration plate at different collection times is different.

Other embodiments of the disclosure will be apparent to those skilled in the art from consideration of the specification and practice of the disclosure disclosed here. This application is intended to cover any variations, uses, or adaptations of the disclosure following the general principles thereof and including such departures from the disclosure as come within known or customary practice in the art. It is intended that the specification and examples be considered as exemplary only, with a true scope and spirit of the disclosure being indicated by the following claims.

The above are only some embodiments of the present disclosure, and are not intended to limit the present disclosure. Any modification, equivalent substitution, improvement, etc. made within the spirit and principle of the present disclosure should be included in the scope of protection of the present disclosure.

1. A calibration method for a sensor comprising a camera and a radar, the calibration method comprising:
collecting a plurality of images of a calibration plate in respective position-orientations by the camera, wherein the calibration plate is located within a common field of view range of the radar and the camera;
collecting multiple sets of radar point cloud data of the calibration plate in the respective position-orientations by the radar;
establishing corresponding relationships between the plurality of images and the multiple sets of radar point cloud data based on the respective position-orientations of the calibration plate, wherein, for each of the respective position-orientations of the calibration plate, a corresponding relationship exists between an image of the plurality of images and a set of the multiple sets of radar point cloud data. that are collected in the respective position-orientation of the calibration plate;
respectively determining multiple sets of target radar point cloud data matched with the calibration plate in the respective position-orientations among the multiple sets of radar point cloud data; and
determining a target extrinsic parameter between the radar and the camera according to the multiple sets of target radar point cloud data and multiple sets of corresponding relationships.

2. The calibration method according to claim 1, wherein respectively determining of the multiple sets of target radar point cloud data matched with the calibration plate in the respective position-orientations among the multiple sets of radar point cloud data comprises:
obtaining an intrinsic parameter of the camera calibrated in advance;
respectively determining an extrinsic parameter of the calibration plate in each of the respective position-orientations relative to the camera according to the intrinsic parameter of the camera and the plurality of images; and
for the calibration plate in each of the respective position-orientations, determining a set of target radar point cloud data matched with the calibration plate in the position-orientation among the multiple sets of radar point cloud data according to the extrinsic parameter of the calibration plate relative to the camera and an extrinsic parameter reference value between the radar and the camera.

3. The calibration method according to claim 2, wherein determining the set of target radar point cloud data matched with the calibration plate in the position-orientation among the multiple sets of radar point cloud data according to the extrinsic parameter of the calibration plate relative to the camera and the extrinsic parameter reference value between the radar and the camera comprises:
determining a candidate position of the calibration plate in the position-orientation among the multiple sets of radar point cloud data according to the extrinsic parameter of the calibration plate relative to the camera and an extrinsic parameter reference value between the radar and the camera;
determining a target plane where the calibration plate is located in the position-orientation among the multiple sets of radar point cloud data according to the candidate position; and
determining the set of target radar point cloud data matched with the calibration plate in the position-orientation on the target plane corresponding to the multiple sets of radar point cloud data.

4. The calibration method according to claim 3, wherein determining the target plane where the calibration plate is located in the position-orientation among the multiple sets of radar point cloud data according to the candidate position comprises:
determining a plurality of first radar groups among the multiple sets of radar point cloud data in the position-orientation, wherein each of the plurality of first radar groups comprises a plurality of first radar points randomly selected and located in an area corresponding to the candidate position, and parts of the plurality of first radar points included in different first radar groups are same or different;
for each of the plurality of first radar groups, determining a first plane corresponding to the first radar group, wherein the first plane corresponding to the first radar group comprises a plurality of first radar points of the first radar group;
for each of the first planes for the plurality of first radar groups, determining distances from other radar points except the plurality of the first radar points in the multiple sets of radar point cloud data in the position-orientation to the first plane;
for each of the first planes, determining radar points having a distance less than a threshold among the other radar points as second radar points;
for each of the first planes, determining the second radar points as radar points included in the first plane; and
determining a first plane comprising a largest number of radar points as the target plane among the first planes.

5. The calibration method according to claim 3, wherein determining the set of target radar point cloud data matched with the calibration plate on the target plane corresponding to the multiple sets of radar point cloud data in the position-orientation comprises:
determining an initial first circular area according to a size of the calibration plate on the target plane;
selecting a radar point located in the initial first circular area among the multiple sets of radar point cloud data as a first center of a first circular area to determine a position of the first circular area in the multiple sets of radar point cloud data;
respectively obtaining a plurality of first vectors by taking the first circle center as a starting point and a plurality of third radar points located in the first circular area in the multiple sets of radar point cloud data as ending points;
adding the plurality of first vectors to obtain a second vector;
determining a target center position of the calibration plate based on the second vector; and
determining the set of target radar point cloud data matched with the calibration plate among the multiple sets of radar point cloud data according to the target center position of the calibration plate and the size of the calibration plate.

6. The calibration method according to claim 5, wherein determining the target center position of the calibration plate based on the second vector comprises:
taking an ending point of the second vector as a second circle center, and determining a second circular area according to the second circle center and the size of the calibration plate;
respectively determining a plurality of third vectors by taking the second circle center as a starting point and a plurality of fourth radar points located in the second circular area in the multiple sets of radar point cloud data as ending points;
adding the plurality of third vectors to obtain a fourth vector;
determining whether a vector value of the fourth vector converges to a preset value;
in response to determining that the vector value of the fourth vector does not converge to the preset value, taking an ending point of the fourth vector which does not converge as the second circle center, and redetermining the plurality of third vectors and the fourth vector;
in response to determining that the vector value of the fourth vector converges to the preset value, taking the second circle center corresponding to the fourth vector which converges as a candidate center position of the calibration plate; and
if the candidate center position is coincident with a center position of the calibration plate, taking the candidate center position as the target center position.

7. The calibration method according to claim 6, further comprising:
if the candidate center position is not coincident with the center position of the calibration plate, redetermining the candidate center position.

8. The calibration method according to claim 1, wherein each of the multiple sets of corresponding relationships comprises a plurality of corresponding relationships, and parts of the plurality of corresponding relationships included in different sets of corresponding relationships are same or different, and
wherein determining the target extrinsic parameter between the radar and the camera according to the multiple sets of target radar point cloud data and the multiple sets of corresponding relationships comprises:
respectively determining a plurality of candidate extrinsic parameters between the radar and the camera according to the multiple sets of target radar point cloud data and the multiple sets of corresponding relationships; and
determining the target extrinsic parameter between the radar and the camera according to the plurality of candidate extrinsic parameters.

9. The calibration method according to claim 8, wherein determining the target extrinsic parameter between the radar and the camera according to the plurality of candidate extrinsic parameters comprises:
projecting the calibration plate on one of the plurality of images by the radar based on each of the plurality of candidate extrinsic parameters to generate a set of projection data;
determining a set of projection data having a highest matching degree with the image among multiple sets of projection data as target projection data; and
determining a candidate extrinsic parameter corresponding to the target projection data as the target extrinsic parameter between the radar and the camera.

10. The calibration method according to claim 1, wherein the radar and the camera are deployed on a vehicle.

11. The calibration method according to claim 1, Wherein the plurality of images comprise a complete calibration plate, and the multiple sets of radar point cloud data comprise point cloud data obtained based on the complete calibration plate.

12. The calibration method according to claim 1, wherein the radar comprises a lidar, and a laser line emitted by the lidar intersects a plane where the calibration plate is located.

13. The calibration method according to claim 1, wherein the calibration plate in the respective position-orientations comprises:
a calibration plate which is different from at least one of a distance between the camera and the radar or an orientation in a horizontal direction.

14. A calibration apparatus for a sensor comprising a camera and a radar, the calibration apparatus comprising:
at least one processor; and
at least one non-transitory memory coupled to the at least one processor and storing programming instructions for execution by the at least one processor to perform operations comprising:
collecting a plurality of images of a calibration plate in respective position-orientations by the camera, wherein the calibration plate is located within a common field of view range of the radar and the camera;
collecting multiple sets of radar point cloud data of the calibration plate in the respective position-orientations by the radar;
establishing corresponding relationships between the plurality of images and the multiple sets of radar point cloud data based on the respective position-orientations of the calibration plate, wherein, for each of the respective position-orientations of the calibration plate, a corresponding relationship exists between an image of the plurality of images and a set of the multiple sets of radar point cloud data that are collected in the respective position-orientation of the calibration plate;
respectively determining multiple sets of target radar point cloud data matched with the calibration plate in the respective position-orientations among the multiple sets of radar point cloud data; and
determining a target extrinsic parameter between the radar and the camera according to the multiple sets of target radar point cloud data and multiple sets of corresponding relationships.

15. The calibration apparatus according to claim 14, wherein respectively determining of the multiple sets of target radar point cloud data matched with the calibration plate in the respective position-orientations among the multiple sets of radar point cloud data comprises:
obtaining an intrinsic parameter of the camera calibrated in advance;
respectively determining an extrinsic parameter of the calibration plate in each of the respective position-orientations relative to the camera according to the intrinsic parameter of the camera and the plurality of images; and
for the calibration plate in each of the respective position-orientations, determining a set of target radar point cloud data matched with the calibration plate in the position-orientation among the multiple sets of radar point cloud data according to the extrinsic parameter of the calibration plate relative to the camera and an extrinsic parameter reference value between the radar and the camera.

16. The calibration apparatus according to claim 15, wherein determining the set of target radar point cloud data matched with the calibration plate in the position-orientation among the multiple sets of radar point cloud data according to the extrinsic parameter of the calibration plate relative to the camera and the extrinsic parameter reference value between the radar and the camera comprises:
determining a candidate position of the calibration plate in the position-orientation among the multiple sets of radar point cloud data according to the extrinsic parameter of the calibration plate relative to the camera and an extrinsic parameter reference value between the radar and the camera;
determining a target plane where the calibration plate is located in the position-orientation among the multiple sets of radar point cloud data according to the candidate position; and
determining the set of target radar point cloud data matched with the calibration plate in the position-orientation on the target plane corresponding to the multiple sets of radar point cloud data.

17. The calibration apparatus according to claim 16, wherein determining the target plane where the calibration plate is located in the position-orientation among the multiple sets of radar point cloud data according to the candidate position comprises:
determining a plurality of first radar groups among the multiple sets of radar point cloud data in the position-orientation, wherein each of the plurality of first radar groups comprises a. plurality of first radar points randomly selected and located in an area corresponding to the candidate position, and parts of the plurality of first radar points included in different first radar groups are same or different;
for each of the plurality of first radar groups, determining a first plane corresponding to the first radar group, wherein the first plane corresponding to the first radar group comprises a plurality of first radar points of the first radar group;
for each of the first planes for the plurality of first radar groups, determining distances from other radar points except the plurality of the first radar points in the multiple sets of radar point cloud data in the position-orientation to the first plane;
for each of the first planes, determining radar points having a distance less than a threshold among the other radar points as second radar points;
for each of the first planes, determining the second radar points as radar points included in the first plane; and
determining a first plane comprising a largest number of radar points as the target plane among the plurality of first planes.

18. The calibration apparatus according to claim 16, wherein determining the set of target radar point cloud data matched with the calibration plate on the target plane corresponding to the multiple sets of radar point cloud data in the position-orientation comprises:
determining an initial first circular area according to a size of the calibration plate on the target plane;
selecting a radar point located in the initial first circular area among the multiple sets of radar point cloud data as a first center of the first circular area to determine a position of the first circular area in the multiple sets of radar point cloud data;
respectively obtaining a plurality of first vectors by taking the first circle center as a starting point and a plurality of third radar points located in the first circular area in the multiple sets of radar point cloud data as ending points;
adding the plurality of first vectors to obtain a second vector;
determining a target center position of the calibration plate based on the second vector; and
determining the set of target radar point cloud data matched with the calibration plate among the multiple sets of radar point cloud data according to the target center position of the calibration plate and the size of the calibration plate.

19. The calibration apparatus according to claim 18, wherein determining the target center position of the calibration plate based on the second vector comprises:
taking an ending point of the second vector as a second circle center, and determining a second circular area according to the second circle center and the size of the calibration plate;
respectively determining a plurality of third vectors by taking the second circle center as a starting point and a plurality of fourth radar points located in the second circular area in the multiple sets of radar point cloud data as ending points;
adding the plurality of third vectors to obtain a fourth vector;
determining whether a vector value of the fourth vector converges to a preset value;
in response to determining that the vector value of the fourth vector does not converge to the preset value, taking an ending point of the fourth vector which does not converge as the second circle center, and redetermining the plurality of third vectors and the fourth vector;
in response to determining that the vector value of the fourth vector converges to the preset value, taking the second circle center corresponding to the fourth vector which converges as a candidate center position of the calibration plate; and
in response to determining that the candidate center position is coincident with a center position of the calibration plate, taking the candidate center position as the target center position.

20. A calibration system, comprising:
a camera;
a radar;
a calibration plate, wherein the calibration plate is located within a common field of view range of the camera and the radar, and position-orientation information of the calibration plate at different collection times is different; and
a calibration apparatus comprising:
at least one processor; and
at least one non-transitory memory coupled to the at least one processor and storing programming instructions for execution by the at least one processor to perform operations comprising:
collecting a plurality of images of the calibration plate in respective position-orientations by the camera;
collecting multiple sets of radar point cloud data of the calibration plate in the respective position-orientations by the radar;
establishing corresponding relationships between the plurality of images and the multiple sets of radar point cloud data based on the respective position-orientations of the calibration plate, wherein, for each of the respective position-orientations of the calibration plate, a corresponding relationship exists between an image of the plurality of images and a set of the multiple sets of radar point cloud data that are collected in the respective position-orientation of the calibration plate;
respectively determining multiple sets of target radar point cloud data matched with the calibration plate in the respective position-orientations among the multiple sots of radar point cloud data; and
determining a target extrinsic parameter between the radar and the camera according to the multiple sets of target radar point cloud data and multiple sets of corresponding relationships.
